(19) United States
(12) Patent Application Publication
(10) Pub. No.: US 2004/0043234 A1
(43) Pub. Date: Mar. 4, 2004

(54) Light management films and articles thereof

(76) Inventors: Grant Hay, Evansville, IN (US); Chung-hei Yeung, Evansville, IN (US)

Correspondence Address: Henry H. Gibson, GE Plastics, One Plastics Avenue, Pittsfield, MA, 01201, US

(21) Appl. No.: 10/435,233

(22) Filed: May 9, 2003

Related U.S. Application Data
(60) Provisional application No. 60/380,246, filed on May 10, 2002.

(51) Int. Cl. G02B 5/30

(52) U.S. Cl. 428/496; 359/487

(57) ABSTRACT

A light management film having internal refraction or reflection properties comprising an arylate polyester polymer having reheological properties suitable for micro replications of surface structures during the application of heat and pressure, and a suitable refractive index of from about 1.4 to about 2.0.

### CROSS-REFERENCE TO RELATED APPLICATIONS

This application claims the benefit of the filing date of U.S. Provisional Application Serial No. 60/380,246 filed May 10, 2002; the entire contents of which are hereby incorporated by reference.

### FIELD OF THE INVENTION

This invention relates to light management films having refraction or reflection.

### Background of the Invention

Light management films describe a broad class of articles that are used in many applications including retro reflective signage products and brightness enhancement films for LCD (liquid crystal display) backlights. Light management products covers a broad range of articles including retro reflective products for the safety industry, films for light management in flat panel displays, front panels for vending machines, outdoor/indoor lighting, architectural glazing, outdoor furniture, outdoor mirrors and solar collectors just to name a few.

Brightness enhancement is well known in the LCD backlight industry. At a constant light output from the light source, it is highly desirable to increase the luminance over a certain region, typically center, of the LCD screen in order to maximize comfort and usability for the viewer. But given the constant light output from the light source, an optical mechanism that redirects the outgoing light beams needs to be implemented. This mechanism of light redirection is typically achieved via the use of what is known to those skilled in the art as brightness enhancement films. These films typically have microstructures on one or both surfaces of the film, which enables light redirection. The amount of redirection, or refraction, depends on not only the shapes and sizes of the microstructures, but also on the index of refraction of the material on which the microstructures are formed.

Retro reflective materials are well known in the safety products industry. Constructions are used extensively in making reflectors, which find utility in pavement markers, reflective tapes, reflective vests and belts, bands for posts and barrels, traffic cone collars, vehicle reflectors and like articles, or in the form of sheeting, which finds utility in highway signs, warning reflectors, safety garments and the like. These safety articles are typically required to adhere to government purchasing standards. These require the products to meet specific requirements around retro reflectivity, color, flexibility, dimensional stability and resistance to cracking and weathering to name a few.

Compositions and weatherable multilayer articles comprising resorcinol arylate chain members are known. See EP 1124878 and WO 0069945 both of which are incorporated herein by referenced in their entirety. The prior art references generally discuss methods to manufacture multilayer articles by various processes including co-injection molding, coextrusion, overmolding, multi-shot injection molding, sheet molding and placement of a film of the coating layer material on the surface of a substrate layer optionally followed by adhesion of the two layers by a tie-layer, with the coating layer comprising resorcinol arylate polyester chain members. In some applications, the multilayer article as taught in the prior art may be separated into the constituent substrate layer and the coating layer comprising resorcinol arylate chain members. If applied onto a substrate, i.e., wood, metal, plastic, paper, etc. as a protective carrier or weatherable layer, the inter-layers or intra-layers in the prior art may undergo separation.

In brightness enhancement films, the use of such polyarylate copolymer bearing high refractive index is desirable. The high refractive index of such material allows a higher degree of light refraction given a set of pre-determined microstructures, which in turns allows a higher degree of brightness increase for LCD backlight applications.

In the retro reflective safety products market, it is of paramount importance to have a substrate with excellent weathering properties. As outlined above most light management film products require a specific geometry to be cast or embossed into the polymer surface. For most light management film applications the size of the structure is on the order of several microns to tens of microns and it is usually imperative that the replicated structures are almost identical to the master. Hence, it is of paramount importance that the Theological properties of the material are optima for the embossing process.

### SUMMARY OF THE INVENTION

A light management film having refraction or reflection properties comprising an arylate polyester polymer having reheological properties suitable for micro replications of surface structures during the application of heat and pressure, and a refractive index from about 1.4 to about 2.0, preferably from about 1.5 to about 1.7, and more preferably from 1.60 to about 1.63.

The arylate polyester polymer desirable has a desirable balance of properties including suitable refractive index, weathering, UV stability performance and processability for enhanced light management film applications.

For light management applications there are some common material properties that are desirably optimized to improve the performance of the final product. All of these products typically manage light via redirection utilizing the properties of refraction and reflection. One comnon phenomena utilized is total internal reflection (TIR). For a given dielectric interface between two materials (i.e. air and polymeric resin) there is an angle of incidence where all of the incident light is reflected from the interface similar to specula reflection. By utilizing this phenomena and controlling the incident light/dielectric interface geometry light can be managed in many beneficial ways. Typically a predefined geometry is created in the resinous material via some embossing process. The angle at which TIR occurs (θ_{c}) is directly related to the refractive index of the material via the following relation:

$${θ}_{c} = {sin}^{- 1} ( \frac{1}{n} )$$

This illustrates that as n increases θ_{c} decreases. Hence as n increases TIR will occur for a broader range of incident angles. Typically this leads to enhanced performance in many light management film products and applications. The polymeric resin that is the subject of the current invention can have a refractive index as high as 1.62 which is approximately 20% higher than that of BPA polycarbonate. This will allow enhanced performance of many light management film products.

### BRIEF DESCRIPTION OF THE DRAWINGS

FIG. 1 illustrates the weathering properties of the arylate polyester in different regions of the world.

FIG. 2 illustrates the weathering properties of the arylate polyester in a Zeon arc weatherometer.

FIG. 3 illustrates the configuration of Theological properties of the arylate polyester resin.

FIG. 4 is a schematic view illustrating a method of applying a masking layer to the multilayer article of the present invention.

FIG. 5 is a schematic cross-sectional view illustrating a laminate as described herein.

### DESCRIPTION OF THE INVENTION

This invention is directed to a light management film comprising resorcinol arylate polyester chain members. The film comprises arylate polyester chain members. The chain members comprise at least one diphenol residue in combination with at least one dicarboxylic acid residue.

Suitable dicarboxylic acid residues include aromatic dicarboxylic acid residues derived from monocyclic moieties, preferably isophthalic acid, terephthalic acid, or mixtures of isophthalic and terephthalic acids, or from polycyclic moieties, including diphenyl dicarboxylic acid, diphenylether dicarboxylic acid, naphthalenedicarboxylic acid such as naphthalene-2,6-dicarboxylic acid. In one embodiment, the dicarboxylic acid is 1,4-cyclohexanedicarboxylic acid.

In one embodiment, the diphenol residue is derived from a 1,3-dihydroxybenzene moiety, as illustrated in Formula I, commonly referred to as resorcinol or resorcinol moiety.

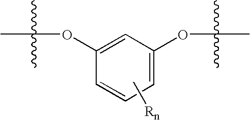

In Formula I, R is at least one of C1-12 alkyl or halogen, and n is 0-3. Examples of Resorcinol or resorcinol moiety includes both unsubstituted 1,3-dihydroxybenzene and substituted 1,3-dihydroxybenzenes.

In one embodiment, the aromatic dicarboxylic acid residues are derived from mixtures of isophthalic and/or terephthalic acids (ITR) as typically illustrated in Formula II.

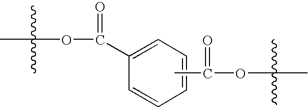

In one embodiment, the light management outer layer or the coating layer comprises resorcinol arylate polyester chain members as illustrated in Formula III wherein R and n are as previously defined:

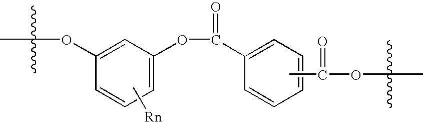

In one embodiment, light management layer is a blend of polymers comprising resorcinol arylate polyester chain members and at least one other polymer selected from at least one of miscible, immiscible, and compatibilized blends including but not limited to: polycarbonates, polyesters, polyetherimides, polyphenylene ethers, PC/ABS, PC/ASA, PC/PBT, PC/PET, PC/polyetherimide, polyamide, polyester/polyetherimide, polyphenylene ether/polystyrene, polyphenylene ether/polyamide, polyphenylene ether/polyester, blends, regrinds and foams of any of the above. In another embodiment, the light management layer is comprised of a block copolyestercarbonate comprising resorcinol arylate-containing block segments in combination with organic carbonate block segments as disclosed in EP 1124878.

In one embodiment of applications wherein high levels of scratch and/or chemical resistance are required, the amount of resorcinol arylate-containing block segments is in the range of about 50 to 100 mole %. In other embodiments with a lesser requirement for scratch and chemical resistance, the level is about 20 to 50 mole percent.

The composition may additionally contain art-recognized additives including but not limited to metal flakes, pigments, dyes, impact modifiers, optical brighteners, UV screeners, flame retardants, fillers, stabilizers, flow aids, ester interchange inhibitors, and mold release agents. Pigments include both clear pigments such as inorganic siliceous pigments (silica pigments for example) and conventional pigments used in coating compositions. In one preferred embodiment, the weatherable coating layer is a clear layer with no pigment or dye in the composition.

The light management layer may be produced as a separate layer, followed by application of additional layers to form a multilayer article. One or more layers may comprise the resorcinol arylate as described above. It can also be produced by simultaneous productions of the layers in a production process. Thus, the weatherable, UV stable coating layer may be produced and employed in such methods but not limited to molding, extrusion, co-injection molding, co-extrusion, overmolding, coating, and the placement of the layer onto the surface of a second layer.

The light management substrate layer may be used in combination with additional layers such as optically transparent layers of a material selected from the group consisting of acrylic polymer, polycarbonate, ionomer, glass, halogenated polymer, polyolefin, polyester, and polyvinyl butyral. By the term polycarbonate is meant carbonate polymers possessing recurring structural units of the formula:

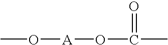

wherein A is a divalent aromatic radical of the dihydric phenol employed in the polymer reaction. Suitable aromatic polycarbonate resins include linear aromatic polycarbonate resins and branched aromatic polycarbonate resins. Suitable linear aromatic polycarbonates resins include, for example, bisphenol A polycarbonate resin. Suitable branched polycarbonates are known and are made in various embodiments by reacting a polyfunctional aromatic compound with a dihydric phenol and a carbonate precursor to form a branched polymer. The term “polyolefin resins” means resins which are polymerized with an olefin monomer such as propylene, ethylene or butene and can be selected according to the required performance of a product such as heat resistance, flexibility and transparency. The resins may be used alone or in admixture of a plurality of polyolefin resins in consideration of their crystallinity, noncrystallinity and elasticity. By the term polyester is meant a thermoset polyester or a thermoplastic polyester. By the term polyamide is meant resins such as nylon-6, nylon-6,6, nylon-6,10, and nylon-6,12.

One or more of the layers may include one or more optical brighteners, colorants, light filtering agents, ultraviolet light absorbers (UVA), hindered amine light stabilizers (HALS), or other materials useful in light management materials. Typical UV absorbers include benzotriazole, benzophenone, triazine, cyanoacrylate, dibenzoylresorcinol, benzoxazinone and oxanilide based UVA. Illustrative ultraviolet radiation absorbing compounds include 2-(benzotriazol-2-yl)-4-(1,1,3,3-tetramethylbutyl)phenol, 2-(benzotriazol-2-yl)-4-methylphenol, 2-hydroxy-4-octyloxy benzophenone, 2-hydroxy-4-methoxybenzophenone, ethyl-2,2-diphenyl-1-cyanoacrylate, 2′-ethylhexyl-2,2-diphenyl-1-cyanoacrylate, 2-(2′-hydroxy-4′-octyloxy) bis-4,6-(2′,4′-dimethylphenyl)triazine, 2-ethyl-2′-ethoxy oxalanide, bis [2-hydroxy-5-methyl-3-(benzotriazol-2-yl)phenyl]-methane, bis[2-hydroxy-5-t-octyl-3-(benzotriazol-2-yl) phenyl]methane, 2,2′-(1,4-phenylene)bis[4 H-3,1-benzoxazin-4-one], and 2-(2′-hydroxy-4-hexyloxy)-4,6-diphenyltriazine. Typical colorants include thioxanthone, perylene imide (e.g. N,N′-bis(2,6-di-isopropylphenyl)-3,4:9,10-perylenebis(dicarboximide)), thioindigoid, perylene, perylene ester, thioxanthene, benzoanthene, benzothiazine, naphthalimide, coumarin, and mixtures thereof. Typical light filtering agents include Solvent Yellow 98, Lumogen F Yellow 083, Lumogen F Orange 240, Lumogen F Red 300, Chromophthal Red 6961 A, CI Solvent Yellow 160:1, Oraset Yellow 8GF, CI Solvent Green 4, CI Solvent Green 5, CI Pigment Yellow 101, Golden Yellow D304, and CI Solvent Yellow 131.

Suitable ITR resins comprising resorcinol arylate blocks are known; see for example the descriptions and methods for preparation given in EP 1124878 and WO 0069945 both of which have been incorporated herein by reference. In one embodiment of a resin comprising resorcinol arylate units, the % of resorcinol arylate is from 10 to 90% and the percent of BPA and resorcinol carbonates is from 10 to 90%.

Suitable copolyestercarbonates are comprised of aromatic BPA polycarbonate units and aromatic polyester units.

A material which is retro reflective is defined as one that can return light toward a non-perpendicular source. This differs from a mirror, which causes specular reflection, and from other diffuse reflecting surfaces that reflect light in all directions. All retroreflectors utilize some predefined geometry and the principle of total internal reflection (TIR) to reflect the light. There are predominately two broad categories encompassing all retroreflective substrates. These are ones that utilize micro replicated corner cube arrays or alternatively spherical glass beads. In both cases a refractive index or dielectric difference is utilized to promote the TIR. The corner cube geometry has been alternately referred to as Trihedral, Tetrahedral and are recognized in the art as describing structure or patterns consisting of three mutually perpendicular faces which are not limited to any particular size, shape relative to the others or any orientation of the optical axis of the cube-corner element. These characteristics can be modified depending on the angular reflective response characteristic required. Other times cube-corner type reflectors are referred to as rectangular parallelepiped. The use of corner-cube arrays for retro reflective substrates has been in wide use for many years. The design and manufacture of such devices for use as road signs, signals or by employing the same as a tail reflector on automobiles. Reflecting devices of such character are illustrated in U.S. Pat. No. 1,591,572, U.S. Pat. No. 1,671,086, U.S. Pat. No. 1,807,350 and U.S. Pat. No. 1,906,655. Most of these early products were circular prisms with the slightly spherical face and corner cubes at the rear. The spherical face was utilized to limit the specular reflection from the glossy surface so that vehicle headlamp images were not created in the surface of the product. The corner cube arrays were also referred to triple reflectors as the light needs to TIR of all three sides to achieve retro reflection back towards the source. In these early circular products letters on signs were formed by arranging the circular buttons to block in a letter. The products would fail regularly due to dirt and water adhering to the corner cube arrays. Once this occurs the cube corners loose their effectiveness. As highlighted in U.S. Pat. No. 3,924,929 and U.S. Pat. No. 4,208,090 to counteract this issue it became typical to form sealed micro cellular structures where multiple arrays would be hermetically sealed at the sides and back with some predefined geometry. This would minimize the access of dirt and water into the structures and guarantee that if a water or dirt entered a single cell that the other cells would be free from contamination. These cells can come in a multitude of forms from triangular to diamond in shape.

The TIR performance over a range of entrance angles for any given cube corner retro reflector is influence by the cube axis cant and the index of the material. For incident angles where there is a loss of retro reflectance it is common to add a metallic coating. Metalization allows a seal to prevent moisture and dirt that destroys retro reflectivity at point of contact and the construction of a full support without an air gap. Unlike TIR, which results in 100% reflectance, aluminum coatings, have approximately 85% reflectance. If the light is reflected off three surfaces the intensity will be reduced to approximately 61% of the TIR intensity. For the corner cube geometry, at each entrance angle β and orientation angle ω of rays reaching the front surface there is a definite internal incidence angle associated with each of the three faces, regardless of the sequence in which the ray encounters the three faces. This internal incidence angle is equal to:

$$Internal Incidence Angle = {cos}^{- 1} [ \frac{\sqrt{{n}^{2} - {sin}^{2} β} - \sqrt{2} sin β cos ( ω - j \cdot {120}^{°} )}{n \sqrt{3}} ]$$

This equation is specific to axial cube corners, i.e., cubes having a diagonal normal to the front surface. This expression can be used with the condition for total internal reflection to calculate for each entrance angle and orientation angle the condition for total internal reflection at each cube face in terms of the refractive index gradient at the interface. For cube corners having a refractive index of 1.5 the critical angle for retro reflection 41.8 degrees. The efficiency of a cube corner will be given by the product of three terms: The reflection coefficient after three successive reflections, the cross section of a cube corner presented to a plane wave after it has penetrated the material. The reflectivity of A=0.9 and for 3 reflections 0.9\hat{ }3=0.729. The transmission coefficient of window (2 passes) is 0.92 if surface is not treated to minimize reflection losses. Thus for perpendicular incidence the efficiency would be 0.67. As the angle of incidence is increased the transmission of window and cross section decrease and overall retro reflective efficiency falls accordingly. Still a practically useful efficiency will be retained at 80-degree incidence in air.

U.S. Pat. No. 3,712,706 details a cube corner retro reflector with unusually high retro reflective efficiency. The cube corners are made so accurately and of such a small size that the applicant claims that diffraction is the predominant factor governing the divergence from perfect retro reflection of the reflected light. It is pointed out that a perfect retro reflector returns all light directly along the axis of retro reflection to the source but the viewer is typically not at the source. All retro reflectors are imperfect to various degrees and the retro reflected light tends to diverge from the axis of retro reflection. The goal is to include the observer's eye within the cone of averaging light while keeping intensity high. The angular divergence of retro reflected light is attributed to optical imperfections. It is noted that the 90-degree dihedral angle of the cube corners must be carefully made within limits that will achieve the needed retro reflective efficiency. If the cube corners are embossed small enough the diffraction effects at lines of intersection between faces in combination with imperfections large divergence effects.

As pointed out above it became necessary to optimize the angular retro reflective performance as needed by the application requirements. A lot of work has been completed with the intent to manipulate the angular retro reflectivity of the article. Typical corner cube retro reflective sheeting is the brightest for on axis incidence but it only reflects within a narrow range of incidence angles. Typically corner cube arrays exhibit a half brightness angle of approximately 21 degrees whereas glass micro sphere retro reflectors can have half brightness angles of approximately 45 degrees. Cube corner arrays also inherently cause a rotational dependence in the performance of the sheeting. Especially for road marker applications where the light from a motor vehicles headlamp is almost parallel to the retro reflective article retro reflection needs to occur at high angles of incidence. U.S. Pat. No. 4,073,568 outlines off center corner cube designs where the body diagonal of the rectangular parallelepiped is within an angle of 15 degrees of incident light refracted from the front face. This produces a product where a better retro reflectivity is obtained for incident light that is impinging on the retro reflector at wider angles of incidence as in the case for road markers. In one form the retro reflector comprises a light-transmitting sheet that is placed in an angled position such that a normal to the sheet is at an angle of about 5 to 85 degrees from an incident beam of light. Other designs would utilize multifaceted retro reflective elements to achieve retro reflection at high incidence angles. However these approaches that require a combination of different retro reflective elements are complex and tend to be difficult and expensive to achieve in practice. U.S. Pat. No. 4,349,598 outlines a new product with a new retro reflective element design. As compared to the regular cube corners that have maximum retro reflectivity at very small departures from normal incidence this design has its maximum retro reflectivity at angles of incidence of about 45 to 80 degrees making it perfect for road marking applications. The reflecting elements are disclosed as reflecting right triangle prisms, that is, transparent bodies having a rectangular base, two mutually perpendicular rectangular faces meeting the base at 45 degree angles, and two parallel triangular faces perpendicular to the rectangular faces. The triangular and rectangular faces thus together define a pair of cube corner retro reflectors.

U.S. Pat. No. 4,895,428 also addresses the need for improved retro reflectivity at high angles of incidence. It is again highlighted that 90 degree cube corners loose retro reflectivity significantly at incidence angles greater than approximately 20 degrees and nearly all retro reflectivity is lost at incidence angles of 40 degrees. It is pointed out that the design in the White patent has limitations due to the required vertical cuts between the reflecting elements. These cuts cause a 25-50% loss in the retro reflective area (effective area) and the embossing/molding process is difficult with the two right angle sides. It leads to the need for large stresses to pull the material from the mold and hence damage of the part on removal. A canted trihedral angle cube corner may have an effective aperture of 30% and a White design roughly 70% so there is still plenty of room to improve the effective aperture to 100%. The retro reflective material outlined in this invention comprises a transparent surface layer and an array of reflecting elements, each of the reflecting elements including a rectangular base having a length L, two tetragonal faces nearly perpendicular to each other and having a line of intersection length Y, the length Y being less than the said length L, a triangular face nearly perpendicular to the tetragonal faces; and a non perpendicular triangular face forming an angle alpha with the plane perpendicular to the base, the angle alpha being preferably about sin−1(0.25/n) to sin⁻¹(1/n) and more preferably about sin ⁻¹(0.35/n) to sin ⁻¹(0.9/n), where n is the refractive index of the reflecting elements. The perpendicular triangular face and the tetragonal faces define an approximate cube corner with the non-perpendicular triangular face and the tetragonal faces forming a non-orthogonal corner. To those skilled in the art this design can still be referred to as cube corners as it resembles in shape and function. The angle alpha is preferred to be no greater than the critical angle for TIR of the material and is typically in range of 6 to 65 degrees. The geometry can be designed so that the effective aperture will be close to 100%. U.S. Pat. No. 4,703,999 is another design that brings corner cube arrays to half brightness angle that compares to glass micro sphere performance. The cube-corner retro reflector of this invention comprises a transparent layer configured on its rear surface with cube-corner retro reflective elements which retro reflect light beamed against the front of the layer, and a specularly reflective layer having a specularly reflective surface which is a negative of the configured rear surface of the transparent layer and which is interfitted with and closely spaced from said rear surface, with the adjacent and matching portions of the specularly reflective and rear surfaces being substantially parallel to one another. The color of the retro reflector is substantially unaffected by the specularly reflected layer. This design produces 1718 candela/lux/m2 at a −4 degree incident angle with an observation angle of 0.2 degrees and rotation angle of 0 degrees where 0 is incidence plane is parallel to a groove. The intensity at incidence angles of 30 and 45 degrees respectively was 1016 and 425 ca/luxm2. In comparison a typical sheet without the dual elements resulted in 485 and 168 ca/luxm² at the same incident angles. The main challenge with this design is the mode for manufacture given the difficulty of producing the structures in the prescribed format.

To obtain retroreflection a refractive index difference/dielectric difference is needed to induce TIR. Typically this is achieved by having an air-gap between the microstructure and the mounting structure. As can be appreciated this leads to issues with the integrity and dimensional stability of the article. It leaves for contamination of the structure with dirt and water and the structural integrity can be easily compromised. As stated above ways around this have been to hermetically seal the micro prisms into collections of arrays via ultrasonic welding, adhesives or heat sealing. This still has the issue that the retro electivity is lost from the area of the seal. It is common to coat the retro reflective element surfaces with a vacuum deposited aluminum layer to provide a retro reflective interface. This allows the backing to be laminated to the supporting structure rather than having an air gap. U.S. Pat. No. 4,801,193 points out that for corner cube micro prisms less than about 0.010 inch on center spacing that at incident angles of 30 degrees or more the retro reflectivity of light is greater for the metalized product as compared to one that is unmetalized. The use of a metalized aluminum coating on the prism surfaces tends to produce a grey coloration to the observer in ambient light or daylight conditions. In some applications, this grey appearance is considered aesthetically undesirable. This patent points to the use of a second coating that is utilized to protect the metal coating during exposure to a solvent. This then allows for pure retro reflection via TIR at low incidence angles and specular reflection from the metal at high incidence angles. This allows for retro reflectivity over a broader range of incidence angles while still allowing lamination to a support structure without an air gap. WO 98/59265 outlines a similar technology where a low refractive index transparent coating off uniform thickness is applied to the corner-cube arrays followed by a metallic coating. The refractive index difference between the substrate material that the prisms are embossed into and the low index coating is tailored to promote retro reflectance (TIR) from the interface and the remaining light is specularly reflected by the metallic coating. This construction matches the retro reflectance of air-backed constructions while exceeding the entrance angularity performance and equaling the structural integrity of metallized constructions. With this construction there is no need for the air cells typically employed. As called out in the patent a possible candidate for this second layer is cryolite, which has a refractive index of 1.32. This layer is usually deposited via a chemical or vacuum deposition process at a thickness of 2-3 microns.

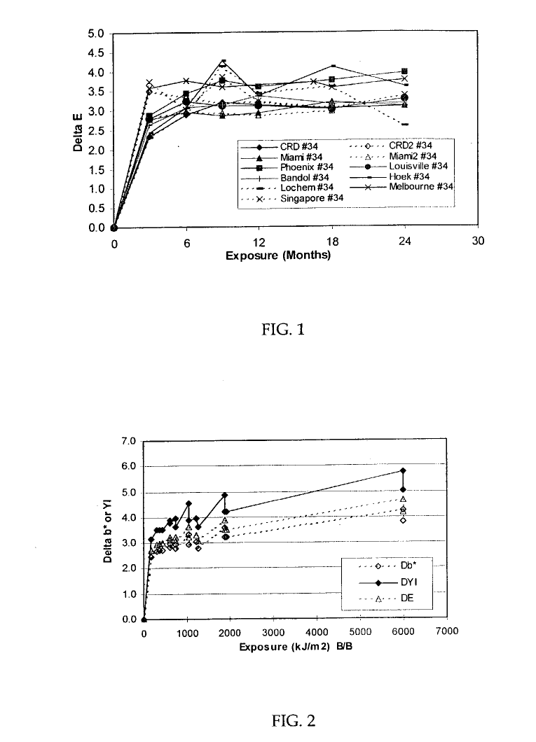

U.S. Pat. No. 5,213,872 incorporated herein by reference in its entirety, describes retroreflective unitary laminate material on which the sign is printed. U.S. Pat. No. 4,601,861 and U.S. Pat. No. 4,618,518 disclose retroreflective sheeting and method and apparatus for embossing a precision optical pattern in a resinous sheet or laminate. In particular, these latter two patents relate to cube corner type retroreflective sheeting having particular use in making highway signs, street signs and the like. All of these patents are incorporated herein by reference in their entirety. FIG. 1 of U.S. Pat. No. 5,213,872 is a schematic representation of the machine as disclosed in U.S. Pat. No. 4,601,861 for producing cube corner type retroreflective sheeting. As can be seen in FIG. 1, a supply reel 36 of unprocessed web 13 is mounted on the right hand end of the machine, as is a supply reel 40 of transparent plastic film. In the '872 patent, the web 13 may be 0.006″ thick and the film 42 may be 0.002″ thick and may be of any desired width, up to the width of the processing machinery as discussed hereafter. The flat web 13 and the film 42 are fed from reels 36 and 40, respectively to the embossing means 34 over guide rollers (not shown) in the direction of the arrows.

In the '872 patent, the embossing means 34 includes an embossing tool in the form of an endless electroformed metal belt 48 which may be about 0.020″ to 0.030″ in thickness and 115″ in “circumference” and 57″ wide. The width and circumference of the belt 48 will depend in part upon the width of the material to be embossed and the desired embossing speed and the thickness of the belt 48. Belt 48 is mounted on and carried by a heating roller 50 and a post cooling roller 52 having parallel axes. Rollers 50 and 52 may be driven by chains (not shown) to advance belt 48 at a predetermined linear speed in the direction of the arrow. Belt 48 is provided on its outer surface with a continuous female embossing pattern 16 which is shown in U.S. Pat. No. 4,601,861.

Spaced sequentially around the belt, in the '872 patent, for about 180 degrees around the heating roller 50 are a plurality of pressure rollers 58 of a resilient material, preferably silicone rubber, with a durometer hardness ranging from Shore A 20 to 90, but preferably, from Shore A 60 to 90. While rollers 50 and 52 do not necessarily have to be the same size, in one embodiment the diameter of heating roller 50 and the post cooling roller 52 is about 211/2″. The diameter of each roller 58 is about 11″. For purposes of illustration, the spacing between rollers 50 and 52 is shown as greatly exaggerated, given the dimension of the rollers 50, 52 and the belt 48. It would be understood that the gap or free area between the rollers will differ depending on the selected dimensions of the belt 48 and rollers 50 and 52.

In the '872 patent, the web 13 and the film 42, as stated, are simultaneously fed to embossing means 34, where they are superimposed to form a separable laminate 69 which is introduced between the belt 48 and the leading pressure roller 58a with the web 13 between the film 42 and the belt 48. One face of the web 13 directly confronts and engages the embossing pattern on the belt 48 and one face of the film 42 directly confronts and engages pressure rollers 58. The laminate 69 is moved with the belt 48 to pass under the remaining pressure rollers 58 and around the heating roller 50 and from thence along belt 48 through a general planar cooling station 80 located between the heating roller 50 and post cooling roller 52. The operation of the cooling station 80 is described in detail in U.S. Pat. No. 4,601,861.

The embossing means 34 includes a stripper roller 70, around which laminate 69 is passed to remove the same from the belt 48 shortly after the belt 48 itself contacts post cooling roller 52 on its return path to the heating roller 50. The laminate 69 then continues through the path illustrated in FIG. 1 to complete the embossed sheeting. As previously manufactured, an additional supply roll (not shown) also may be used to provide a layer 0.002″ thick of VCF A-223 film (VCF is the tradename of VCF Films Division of PMC Inc. for an acrylic copolymer with an ultraviolet absorbing material to enhance weathering).

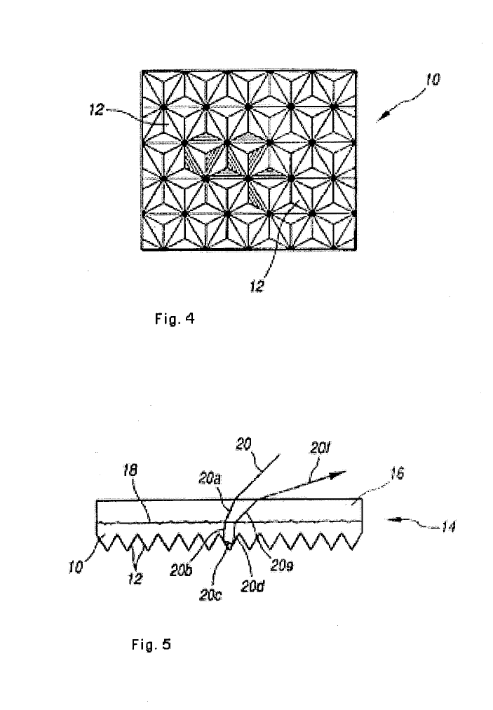

U.S. Pat. No. 6,375,776 describes Method for forming Multi-layer Laminates with Microstructures. This patent in its entirety is incorporated by reference into the present specification. As set forth in the '776 patent, in reference to FIG. 1 of the '776 patent which is identical to FIG. 4 of the present application, a section of retroreflective film is shown in plan view and designated generally by the reference numeral 10. The film 10 is of transparent thermoplastic material having embossed on one surface thereof a repeating pattern of cube-corner type reflector elements 12. Film 10 initially had parallel front and back surfaces and was between 0.0015 to 0.008 inches thick, however, depending upon the desired properties of the retroreflective sheeting, other gauges may be used. The retroreflective pattern was formed with the aid of an embossing tool of a thin flexible metal belt of the type disclosed in U.S. Pat. No. 4,601,861, assigned to the common assignee herein and incorporated herein by reference in its entirety, and as will be discussed in detail hereinafter.

FIG. 2 of the '776 patent which corresponds to FIG. 5 of the present application, illustrates a multi-layer sheeting 14 comprising, for example, a lower layer of film 10 embossed with retroreflective elements 12 and shown as being bonded to an upper layer of a dissimilar film 16, where film 16 also has a refractive index not equivalent to that of film 10. Direct bonding of the embossed film 10 to film 16 as discussed above creates a rough or random non-optically smooth interface 18 between the two films. An incident ray of light 20 is refracted first at the top surface of film 16 into ray 20a. When ray 20a meets the non-optically smooth interface 18 between the two different polymer films 10 and 16, due to the rough interface between the two different polymer films, the incident light ray 20a is not refracted into ray 20b solely according to Snell's Law of Refraction. Ray 20b will be reflected at the surfaces of retroreflective element 12 as rays 20c and 20d, in accordance with known optical principles. Similarly, upon the return of ray 20d to interface 18 after retroreflection in the retroreflective element 12, light ray 20d is not refracted solely according to Snell's Law of Refraction into 20e. Hence, ray 20e is generally not parallel to 20a, and exiting ray 20f is generally not parallel to incident ray 20. Thus, low levels of retroreflection result, and sheeting 14 constructed by such a direct bonding technique may be unacceptable for many uses of retroreflective sheeting.

As set forth in the '872 patent, individuals familiar with the art of microprismatic retroreflective films will recognize that if the two different polymer films 10 and 16 have substantially equivalent refractive indexes, the above described problems will not exist, even with a non-optically smooth interface, and high levels of retroreflection can be maintained.

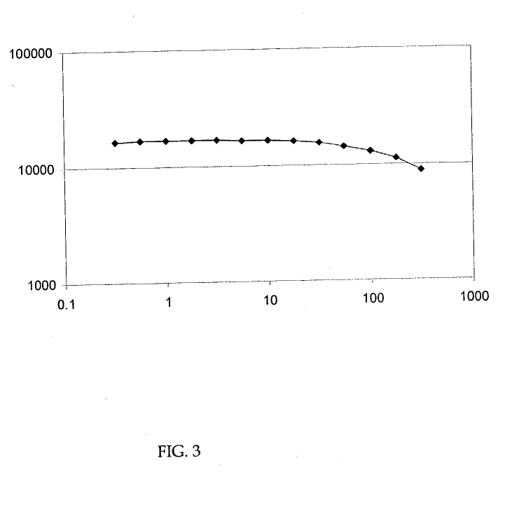

As set forth in the '872 patent, FIG. 3 illustrates sheeting 22 with film 10 being bonded to another dissimilar film 24 and with an optically smooth interface 26 there between. In this example of sheeting 22, incident light 28 is refracted at the interface 26 primarily in accordance with Snell's Law of Refraction, both as it enters interface 26 and as it leaves interface 26, such that light exiting sheeting 22 is reflected substantially parallel back to its source, resulting in good retroreflective performance, even if films 10 and 24 have refractive indexes that are not substantially equivalent.

As set forth in the '872 patent, FIG. 4, an embosser apparatus constructed according to the invention is designated generally by the reference numeral 30. This apparatus is very similar in design and configuration to the apparatus disclosed in the aforementioned U.S. Pat. No. 4,601,861. To this end, it comprises as a principal component, an endless, seamless metal belt or tool 32 which is rotatable about a heating roller 34 and cooling roller 36. The outer surface of the tool 32 is fabricated with a microprismatic pattern such as minute precision cube-corner elements, which are the reverse of the pattern embossed in the film 10. Spaced sequentially around the heating roller 34, and preferably through a range of about 180 degrees are a plurality of pressure rollers 38, 39, 40, 41 and 42. Each pressure roller is preferably formed from silicone rubber with a durometer hardness ranging from Shore A 60 to 90.

In light management films, it is desirable to control the exit cone angle of light transmitted through the sheet and hence reflect and recycle light that is outside of this exit cone angle. This leads to more efficient use of the light that is emitted from a display backlight. WO 01/27527 A1 and WO 01/27663 are just two examples of prior art that illustrates these types of articles. These types of structures can be integrated into many articles that subside in the display. The film comprising a resorcinol arylate polyester chain members may be shaped into a three-dimensional shape having light management properties. Light management films may be utilized for cover display applications, LCD, forward and backlit, forward and back projection display, OLED (organic light emitting diode), vending machine front panel, outdoor/indoor lighting, visual effects outdoor/cladding/OVAD (outdoor vehicle and devices). For example light guides, diffusers films, brightness enhancement films, transflectors to just to name a few.

### EXAMPLES

The following description will illustrate embodiments of the multilayer articles of the present invention and methods of manufacturing the light management articles of the present invention, some examples with reference to the attached drawings. Unless otherwise specified, the weatherable coating layer comprises a resorcinol arylate-containing block copolyester-carbonate (“ITR”) prepared according to Example 65 of WO 0069945.

### Example 1

ITR is melt-extruded onto a rotating cooled drum to form a film having a thickness of about 6 mil. A stop sign legend is printed thereon and a coating material is applied to the printed surface. The film is then fed through an embossing system as described in U.S. Pat. No. 5,213,872 where corner cube arrays are embossed into the rear (side opposite to the printed side) of the film to form a retroreflective pattern. This pattern is subsequently metallized and an adhesive layer is applied which has a protective coating to stop inadvertent contact with the adhesive. This article is then suitable to be adhered to multiple substrates for use.

### Example 2

A coextruded film of three layers is melt-extruded onto a rotating cooled drum to form a film having a thickness of about 6 mil. The outer most layers are ITR and are on the order of one mil thick with the center layer being polycarbonate. A stop sign legend is printed thereon and a coating material is applied to the printed surface. The film is then fed through an embossing system alike that in U.S. Pat. No. 5,213,872 where corner cube arrays are embossed into the rear (side opposite to the printed side) of the film to form a retroreflective pattern. Cryolite is then coated onto the corner cubes which are subsequently metallized with aluminum. The thickness of the cryolite is on the order of 3-10 microns. An adhesive is subsequently coated onto the metal and an adhesive cover layer is applied. This article is then suitable to be adhered to multiple substrates for use.

### Example 3

ITR is melt-extruded onto a rotating cooled drum to form a film having a thickness of about 6 mil. A right angle prism similar to the structure in WO 01/27663 is embossed into the surface of the film utilizing an embossing system as described in U.S. Pat. No. 5,213,872. This film is then utilized as a brightness enhancement film in an LCD display.

What is claimed is:

1. A light management display film having internal refraction properties comprising an arylate polyester polymer having suitable Theological properties and a refractive index from about 1.4 to about 2.0.

2. A light management film according to claim 1 wherein the arylate polyester polymer comprises resorcinol arylate polyester chain members.

3. A light management film according to claim 2 wherein the chain members comprise at least one diphenol residue in combination with at least one dicarboxylic acid residue.

4. A light management film according to claim 1 wherein the polyester comprises a resorcinol arylate-containing block copolyester-carbonate.

5. A light management film according to claim 1 wherein said film has a structure comprising right angle prisms.

6. A light management film according to claim 1 for displays selected from the group consisting of privacy films, brightness enhancement films, polarization recycling films, and the like.

7. A light management film according to claim 1 having a refractive index from about 1.5 to about 1.7.

8. A light management film according to claim 1 having a refractive index from about 1.60 to about 1.63.

9. A light management film according to claim 1 having an optically transparent adjacent layer.

10. A light management film according to claim 12 wherein the optically transparent adjacent layer comprises a polycarbonate.

11. A light management film according to claim 13 wherein the optically transparent, polycarbonate adjacent layer the light management film have refractive indexes from about 1.5 to about 1.7.

12. A light management film according to claim 1 suitable for applications selected from the group consisting of cover display, LCD, forward and backlit, forward and back projection display, OLED, vending machine front panel, outdoor/indoor lighting and visual effect outdoor/cladding/OVAD.

13. A method of making a light management display film comprising shaping a shaping film comprising a resorcinol arylate polyester chain members into a three-dimensional shape having light management properties.

14. A light management film having two layers including an outer layer comprising a polyarylate co-polymer or polyestercarbonate having a refractive index from about 1.6 to about 1.7, and having plastic or glass beads or microstructures on an outward-facing facet suitable for creating substantial retroreflection or total internal reflection for incoming light rays, and an inner layer comprising a thermoplastic compound.

15. The film of claim 17 comprising microstructures of one or more microprisms, encapsulated lens, corner cubes, discretely random structures, or continuously random structures.

16. A light management film comprising an outer layer with refractive index from about 1.0 to about 1.5; a middle layer comprising polyarylate co-polymer or polyestercarbonate having a refractive index from about 1.6 to about 1.7, having plastic or glass beads or microstructures on the outward-facing facet suitable for retroreflection or total internal reflection; and an inner layer comprising a thermoplastic compound.

17. The film of claim 22 having microstructures comprising one or more microprisms, encapsulated lens, corner cubes, discretely random structures, or continuously random structures.

18. A multi-layer light management film comprising a layer with a refractive index from about 1.0 to about 1.5; a second layer comprising a polyarylate co-polymer or polyestercarbonate having a refractive index from about 1.6 to about 1.7, having plastic or glass beads or microstructures on the outward-facing facet suitable for retroreflection or total internal reflection; and a third layer comprising a thermoplastic compound.

19. The film of claim 27 comprising microstructures of one or more microprisms, encapsulated lens, corner cubes, discretely random structures, or continuously random structures.
